(19) United States
(12) Patent Application Publication
(10) Pub. No.: US 2026/0253552 A1
(43) Pub. Date: Aug. 27, 2026

(54) DISPLAY DEVICE, METHOD OF DRIVING THE DISPLAY DEVICE, AND ELECTRONIC DEVICE INCLUDING THE DISPLAY DEVICE

(71) Applicant: SAMSUNG DISPLAY CO., LTD., YONGIN-SI (KR)

(72) Inventors: DOYEONG PARK, Yongin-si (KR); BYUNGCHANG YU, Yongin-si (KR); DONG HEE SHIN, Yongin-si (KR)

(21) Appl. No.: 19/325,770

(22) Filed: Sep. 11, 2025

(30) Foreign Application Priority Data
Feb. 21, 2025 (KR) 10-2025-0022632

(51) Int. Cl. G09G 3/3266; G09G 3/3275

(52) U.S. Cl. CPC G09G 3/3266; G09G 3/3275; G09G 2300/0452; G09G 2310/08; G09G 2320/0242; G09G 2330/021

(57) ABSTRACT

A display device includes a display panel having a display area and a peripheral area. A gate driver is disposed in the peripheral area and includes odd-numbered stages and even-numbered stages. A first scan start signal line in the peripheral area applies a first scan start signal to a first odd-numbered stage, and a second scan start signal line applies a second scan start signal to a first even-numbered stage after all odd-numbered stages have been driven. The display area includes a first pixel circuit portion electrically connected to the first odd-numbered stage and coupled to a first light-emitting diode that emits a first color. A second pixel circuit portion is spaced apart from the first pixel circuit portion in a first direction, is also electrically connected to the first odd-numbered stage, and is coupled to a second light-emitting diode emitting a second color different from the first color.

### CROSS-REFERENCE TO RELATED APPLICATIONS

This application claims priority under 35 U.S.C. § 119 to Korean Patent Application No. 10-2025-0022632, filed on Feb. 21, 2025, the disclosure of which is incorporated by reference herein in its entirety.

### TECHNICAL FIELD

Embodiments of the present disclosure relate to a display device, a method of driving the display device, and an electronic device including the display device.

### DISCUSSION OF RELATED ART

Generally, a display device includes a display panel, a gate driver, a data driver, and a driving controller. The display panel typically includes a plurality of gate lines, a plurality of data lines, and a plurality of pixels electrically connected to the plurality of gate lines and the plurality of data lines. The gate driver provides gate signals to the gate lines, the data driver provides data voltages to the data lines, and the driving controller controls the gate driver and the data driver.

Various types of gate signals may be applied to each of the pixels. To control the plurality of pixels, the data driver may apply separate data signals through a plurality of amplifiers.

### SUMMARY

Embodiments of the present disclosure provide a display device having improved power efficiency, a method of driving the display device, and an electronic device including the display device.

According to an embodiment of the present disclosure, a display device includes a display panel including a display area and a peripheral area surrounding at least a portion of the display area, a gate driver disposed in the peripheral area and including odd-numbered stages and even-numbered stages, a first scan start signal line disposed in the peripheral area and configured to apply a first scan start signal to a first odd-numbered stage of the odd-numbered stages, and a second scan start signal line disposed in the peripheral area and configured to apply a second scan start signal to a first even-numbered stage of the even-numbered stages after all of the odd-numbered stages are driven. The display device further includes a first pixel circuit portion disposed in the display area, electrically connected to the first odd-numbered stage, and connected to a first light-emitting diode that emits a first color, and a second pixel circuit portion disposed in the display area, electrically connected to the first odd-numbered stage, spaced apart from the first pixel circuit portion in a first direction, and connected to a second light-emitting diode that emits a second color different from the first color.

In an embodiment, the display device further includes a third pixel circuit portion disposed in the display area, electrically connected to the first even-numbered stage, spaced apart from the first pixel circuit portion in a second direction intersecting the first direction, and connected to a third light-emitting diode that emits a third color different from the first and second colors, as well as a fourth pixel circuit portion disposed in the display area, electrically connected to the first even-numbered stage, spaced apart from the third pixel circuit portion in the first direction, and connected to a fourth light-emitting diode that emits the third color.

In an embodiment, the odd-numbered stages are electrically connected to each other by an odd carry line, and the even-numbered stages are electrically connected to each other by an even carry line.

In an embodiment, the first pixel circuit portion and the third pixel circuit portion are symmetrical in a plan view about a virtual extension line extending in the first direction between the first pixel circuit portion and the third pixel circuit portion.

In an embodiment, the display device further includes a first gate line disposed in the display area and extending in the first direction from the first odd-numbered stage, and a second gate line disposed in the display area and extending in the first direction from the first even-numbered stage.

In an embodiment, the first gate line is electrically connected to the first pixel circuit portion and the second pixel circuit portion, and the second gate line is electrically connected to the third pixel circuit portion and the fourth pixel circuit portion.

In an embodiment, the first, second, third, and fourth light-emitting diodes are disposed in a Pentile matrix structure.

In an embodiment, at least a portion of the first light-emitting diode overlaps the first pixel circuit portion in a plan view, at least a portion of the second light-emitting diode overlaps the third pixel circuit portion in the plan view, at least a portion of the third light-emitting diode overlaps the second pixel circuit portion in the plan view, and at least a portion of the fourth light-emitting diode overlaps the fourth pixel circuit portion in the plan view.

In an embodiment, the first color is red, the second color is blue, and the third color is green.

In an embodiment, the first color is blue, the second color is red, and the third color is green.

In an embodiment, the display device further includes a data driver disposed in the peripheral area and spaced apart from the display area in a direction opposite to the second direction. The data driver includes a first amplifier and a second amplifier spaced apart from the first amplifier in the first direction.

In an embodiment, the display device further includes a first data line extending in the second direction from the first amplifier and disposed in the display area, and a second data line extending in the second direction from the second amplifier and disposed in the display area.

In an embodiment, the first data line is electrically connected to the first pixel circuit portion and the third pixel circuit portion, and the second data line is electrically connected to the second pixel circuit portion and the fourth pixel circuit portion.

In an embodiment, the first amplifier alternately applies a first data voltage and a second data voltage to the first data line, and the second amplifier alternately applies the second data voltage and a third data voltage to the second data line.

In an embodiment, the first data voltage applied from the first amplifier is applied to the first pixel circuit portion, the second data voltage applied from the first amplifier is applied to the third pixel circuit portion, the second data voltage applied from the second amplifier is applied to the fourth pixel circuit portion, and the third data voltage applied from the second amplifier is applied to the second pixel circuit portion.

In an embodiment, the first amplifier applies the first data voltage to the first data line during a timing when the odd-numbered stages are driven, and applies the second data voltage to the first data line during a timing when the even-numbered stages are driven, and the second amplifier applies the third data voltage to the second data line during a timing when the odd-numbered stages are driven, and applies the second data voltage to the second data line during a timing when the even-numbered stages are driven.

According to an embodiment of the present disclosure, a method of driving a display device includes applying a first data voltage to a first data line during a timing when odd-numbered stages are driven by a first amplifier. The display device includes a display panel including a display area and a peripheral area surrounding at least a portion of the display area, a gate driver disposed in the peripheral area and including the odd-numbered stages and even-numbered stages, and a data driver disposed in the peripheral area and including the first amplifier and a second amplifier spaced apart from the first amplifier in a first direction. The method further includes applying a second data voltage to the first data line during a timing when the even-numbered stages are driven by the first amplifier, applying a third data voltage to a second data line during a timing when the odd-numbered stages are driven by the second amplifier, and applying the second data voltage to the second data line during a timing when the even-numbered stages are driven by the second amplifier. The odd-number stages are driven sequentially, and the even-numbered stages are driven sequentially after all of the odd-numbered stages are driven.

In an embodiment, the method further includes driving a first odd-numbered stage of the odd-numbered stages using a first scan line, driving a first even-numbered stage of the even-numbered stages using a second scan line, sequentially driving the odd-numbered stages from the first odd-numbered stage to a last odd-numbered stage, and sequentially driving the even-numbered stages from the first even-numbered stage to a last even-numbered stage after the odd-numbered stages have been driven.

In an embodiment, the method further includes driving a first odd-numbered stage of the odd-numbered stages using a scan start line, sequentially driving the odd-numbered stages from the first odd-numbered stage to a last odd-numbered stage, and sequentially driving the even-numbered stages from a last even-numbered stage to a first even-numbered stage. A carry line extending from the last odd-numbered stage drives the last even-numbered stage of the even-numbered stages.

According to an embodiment of the present disclosure, an electronic device includes a display device and a processor configured to drive the display device. The display device includes a display panel including a display area and a peripheral area surrounding at least a portion of the display area, a gate driver disposed in the peripheral area and including odd-numbered stages and even-numbered stages, a first scan start signal line disposed in the peripheral area and configured to apply a first scan start signal to a first odd-numbered stage of the odd-numbered stages, and a second scan start signal line disposed in the peripheral area and configured to apply a second scan start signal to a first even-numbered stage of the even-numbered stages after all of the odd-numbered stages are driven. The display device further includes a first pixel circuit portion disposed in the display area, electrically connected to the first odd-numbered stage, and connected to a first light-emitting diode that emits a first color, a second pixel circuit portion disposed in the display area, electrically connected to the first odd-numbered stage, spaced apart from the first pixel circuit portion in a first direction, and connected to a second light-emitting diode that emits a second color different from the first color, a third pixel circuit portion disposed in the display area, electrically connected to the first even-numbered stage, spaced apart from the first pixel circuit portion in a second direction intersecting the first direction, and connected to a third light-emitting diode that emits a third color different from the first and second colors, and a fourth pixel circuit portion disposed in the display area, electrically connected to the first even-numbered stage, spaced apart from the third pixel circuit portion in the first direction, and connected to a fourth light-emitting diode that emits the third color.

The arrangement of the first, second, third, and fourth light-emitting diodes may be repeatedly disposed along one direction, and the pixel circuit portions connected to the odd-numbered stages and the pixel circuit portions connected to the even-numbered stages may be driven separately at different timings. Accordingly, when data voltages are alternately applied to the first pixel circuit portion controlling the first color and the third pixel circuit portion controlling the third color, all the data voltages corresponding to the first color may be applied first, and then the data voltages corresponding to the third color may be applied. Similarly, when data voltages are alternately applied to the second pixel circuit portion controlling the second color and the fourth pixel circuit portion controlling the third color, all the data voltages corresponding to the second color may be applied first, and then the data voltages corresponding to the third color may be applied.

For example, when the pixel circuit portions connected to the odd-numbered stages and the pixel circuit portions connected to the even-numbered stages are driven at different timings, the number of times data voltages are alternately applied may be reduced. As a result, an amount of power consumed in the display device may be reduced, and a power efficiency of the display device may be improved.

### BRIEF DESCRIPTION OF THE DRAWINGS

The above and other features of the present disclosure will become more apparent by describing in detail embodiments thereof with reference to the accompanying drawings.

FIG. 1 is a perspective view of a display device according to an embodiment of the present disclosure.

FIG. 2 is a plan view showing components of the display device of FIG. 1.

FIG. 3 is a circuit diagram showing an embodiment of a pixel disposed in the display panel of FIG. 2.

FIG. 4 is a plan view showing an embodiment of a pixel circuit portion disposed in the display panel of FIG. 2.

FIG. 5 is a plan view showing an embodiment of a light-emitting diode disposed in the display panel of FIG. 2.

FIG. 6 is a plan view showing an embodiment in which the pixel circuit portion of FIG. 4 and the light-emitting diode of FIG. 5 are overlapped.

FIG. 7 is a cross-sectional view showing an embodiment of a display panel including the pixel circuit portion and the light-emitting diode of FIG. 6.

FIG. 8 is a plan view showing an embodiment of a semiconductor layer included in FIG. 7.

FIG. 9 is a plan view showing an embodiment of a conductive layer included in FIG. 7.

FIG. 10 is a plan view showing an overlap of the semiconductor layer of FIG. 8 and the conductive layer of FIG. 9.

FIG. 11 is a plan view showing an embodiment of the gate driver of FIG. 2.

FIG. 12 is a timing diagram showing a method of driving the gate driver of FIG. 11.

FIG. 13 is a plan view showing an embodiment in which the pixel circuit portion and the light-emitting diode of FIGS. 4 and 5 are overlapped.

FIG. 14 is a plan view showing an embodiment of the gate driver of FIG. 2.

FIG. 15 is a timing diagram showing a method of driving the gate driver of FIG. 14.

FIG. 16 is a block diagram showing an electronic device according to an embodiment of the present disclosure.

FIG. 17 illustrates various embodiments of the electronic device of FIG. 16.

### DETAILED DESCRIPTION

While the present disclosure has been particularly shown and described with reference to embodiments thereof, it will be understood by those of ordinary skill in the art that various changes in form and detail may be made therein without departing from the spirit and scope of the present disclosure as defined by the following claims.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

Spatially relative terms, such as “beneath”, “below”, “lower”, “under”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. Other words used to describe the relationships between components should be interpreted in a like fashion.

As used herein, the singular forms “a,” “an” and “the” are intended to include plural forms as well, unless the context clearly indicates otherwise. It will be further understood that the terms “comprises” and/or “comprising,” when used in this specification, specify a presence of stated features, integers, steps, operations, elements, and/or components, but do not preclude the presence or addition of one or more other features, integers, steps, operations, elements, components, and/or groups thereof.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art, for example, within ±30%, 20%, 10% or 5% of the stated value. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

Herein, a plane may be defined by a first direction D1 and a second direction D2 that intersects the first direction D1. For example, the second direction D2 may be perpendicular to the first direction D1. In addition, a third direction D3 may be a normal direction of the plane. For example, the third direction D3 may be perpendicular to the plane formed by the first direction D1 and the second direction D2.

Embodiments of the present disclosure relate to a display device configured to improve power efficiency and driving performance through an improved arrangement of scan start signal lines, pixel circuit portions, and light-emitting diodes. The display device may include a display panel having a display area and a peripheral area surrounding at least a portion of the display area. A gate driver may be disposed in the peripheral area of the display panel and may include a plurality of odd-numbered stages and even-numbered stages configured to sequentially drive gate signals for the display area.

A first scan start signal line is provided in the peripheral area and applies a first scan start signal to a first odd-numbered stage of the odd-numbered stages. Similarly, a second scan start signal line is configured to apply a second scan start signal to a first even-numbered stage of the even-numbered stages, after all of the odd-numbered stages have been driven. This sequential driving structure may result in a more stable gate driving scheme while enabling simplified timing control and reducing power consumption.

In the display area, the display device may include a first pixel circuit portion connected to a first light-emitting diode emitting a first color and a second pixel circuit portion connected to a second light-emitting diode emitting a different color. These pixel circuit portions may be electrically connected to the first odd-numbered stage. Additionally, a third pixel circuit portion connected to a third light-emitting diode and a fourth pixel circuit portion connected to a fourth light-emitting diode of the same third color are electrically connected to the first even-numbered stage. This configuration may allow for effective color control while reducing simultaneous driving loads, which may result in improved display quality and power efficiency.

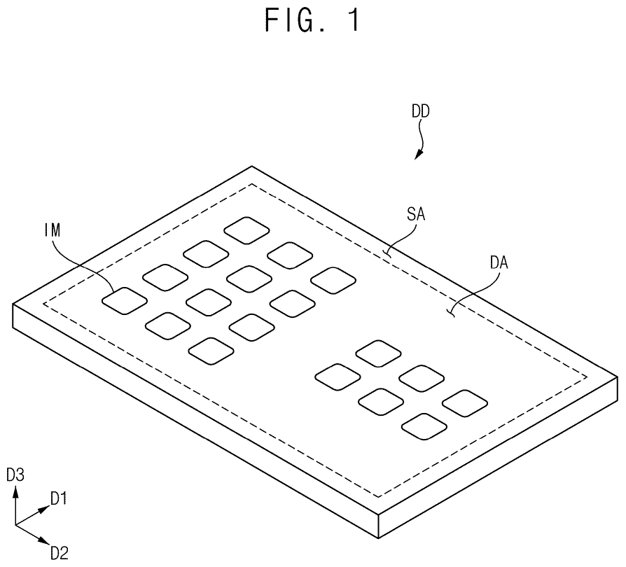

FIG. 1 is a perspective view of a display device according to an embodiment of the present disclosure.

Referring to FIG. 1, a display device DD may include a display area DA and a peripheral area SA. The display area DA may be at least partially surrounded by the peripheral area SA.

The display area DA may be an area capable of generating light. The display area DA may be an area capable of adjusting a transmittance of light provided from an external light source to display an image. The peripheral area SA may be an area that does not display an image. However, embodiments of the present disclosure are not necessarily limited thereto. For example, in an embodiment, at least a portion of the peripheral area SA may also display an image.

The display area DA may display a plurality of images IM, which may convey information from the display device DD to a user.

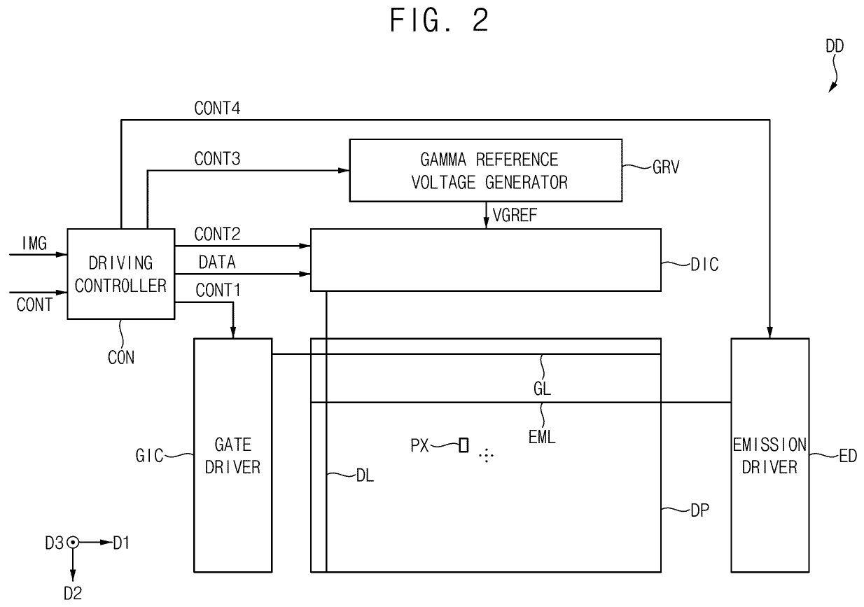

FIG. 2 is a plan view showing components of the display device of FIG. 1.

Referring to FIGS. 1 and 2, the display device DD may include a display panel DP and a display panel driver. The display panel driver may include a driving controller CON (also referred to as a driving controller circuit), a gate driver GIC (also referred to as a gate driver circuit), a gamma reference voltage generator GRV (also referred to as a gamma reference voltage generator circuit), a data driver DIC (also referred to as a data driver circuit), and an emission driver ED (also referred to as an emission driver circuit).

The display panel DP may include the display area DA in which an image is displayed and the peripheral area SA disposed adjacent to the display area DA.

The display panel DP may include a plurality of gate lines GL, a plurality of data lines DL, a plurality of emission lines EML, and a plurality of pixels PX electrically connected to the gate lines GL, the data lines DL, and the emission lines EML, respectively. The gate lines GL may extend from the gate driver GIC in the first direction D1 and may be spaced apart from each other in the second direction D2. The data lines DL may extend from the data driver DIC in the second direction D2 and may be spaced apart from each other in the first direction D1. The emission lines EML may extend from the emission driver ED in a direction opposite to the first direction D1 and may be spaced apart from each other in the second direction D2.

The driving controller CON may receive input image data IMG and input control signals CONT from an external device. For example, the input image data IMG may include red image data, green image data, and blue image data. The input image data IMG may include white image data. The input image data IMG may include magenta image data, yellow image data, and cyan image data. The input control signals CONT may include a master clock signal and a data enable signal. The input control signals CONT may further include a vertical synchronization signal and a horizontal synchronization signal.

The driving controller CON may generate a first control signal CONT1, a second control signal CONT2, a third control signal CONT3, a fourth control signal CONT4, and a data signal DATA based on the input image data IMG and the input control signals CONT.

The driving controller CON may generate the first control signal CONT1 to control an operation of the gate driver GIC based on the input control signals CONT, and may output the first control signal CONT1 to the gate driver GIC. The first control signal CONT1 may include, for example, a scan start signal and a gate clock signal, etc.

The driving controller CON may generate the second control signal CONT2 to control an operation of the data driver DIC based on the input control signals CONT, and may output the second control signal CONT2 to the data driver DIC. The second control signal CONT2 may include, for example, a horizontal start signal and a load signal, etc.

The driving controller CON may generate the data signal DATA based on the input image data IMG. The driving controller CON may output the data signal DATA to the data driver DIC.

The driving controller CON may generate the third control signal CONT3 to control an operation of the gamma reference voltage generator GRV based on the input control signals CONT, and may output the third control signal CONT3 to the gamma reference voltage generator GRV.

The driving controller CON may generate the fourth control signal CONT4 to control an operation of the emission driver ED based on the input control signals CONT, and may output the fourth control signal CONT4 to the emission driver ED.

The gate driver GIC may generate gate signals that drive the gate lines GL in response to the first control signal CONT1 received from the driving controller CON. The gate driver GIC may output the gate signals to the gate lines GL.

The gamma reference voltage generator GRV may generate a gamma reference voltage VGREF in response to the third control signal CONT3 received from the driving controller CON. The gamma reference voltage generator GRV may apply the gamma reference voltage VGREF to the data driver DIC. The gamma reference voltage VGREF may have a value corresponding to each data signal DATA.

For example, the gamma reference voltage generator GRV may be disposed in the driving controller CON or within the data driver DIC.

The data driver DIC may receive the second control signal CONT2 and the data signal DATA from the driving controller CON, and may receive the gamma reference voltage VGREF from the gamma reference voltage generator GRV. The data driver DIC may convert the data signal DATA into an analog data voltage using the gamma reference voltage VGREF. The data driver DIC may output the data voltage to each of the data lines DL.

The emission driver ED may generate emission signals that drive the emission lines EML in response to the fourth control signal CONT4 received from the driving controller CON. The emission driver ED may output the emission signals to the emission lines EML.

In FIG. 2, for convenience of explanation, the gate driver GIC is shown as being spaced apart from the display panel DP in a direction opposite to the first direction D1, and the emission driver ED is shown as being spaced apart from the display panel DP in the first direction D1. However, embodiments of the present disclosure are not necessarily limited thereto. In an embodiment, the gate driver GIC and the emission driver ED may both be disposed on one side (e.g., a side spaced apart in the first direction D1) of the display panel DP. In an embodiment, the gate driver GIC and the emission driver ED may both be disposed on opposite sides of the display panel DP. In an embodiment, the gate driver GIC and the emission driver ED may be integrally formed.

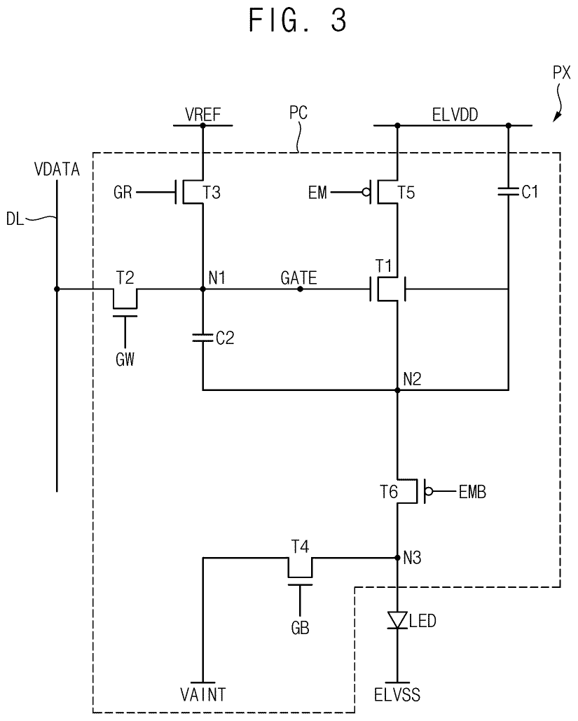

FIG. 3 is a circuit diagram showing an embodiment of a pixel disposed in the display panel of FIG. 2.

Referring to FIGS. 2 and 3, the display panel DP may include the pixels PX disposed in the display area DA. For example, each of the pixels PX may emit one of red light, green light, and blue light, but the disclosure is not necessarily limited thereto. Each of the pixels PX may emit light in which the red light, green light, and blue light to emit are combined.

The pixel PX may include a pixel circuit portion PC and a light-emitting diode LED. The pixel circuit portion PC may include at least one thin film transistor and at least one capacitor. In an embodiment, the pixel circuit portion PC may include a first transistor T1, a second transistor T2, a third transistor T3, a fourth transistor T4, a fifth transistor T5, a sixth transistor T6, a first capacitor C1, and a second capacitor C2.

The first transistor T1 may include a gate electrode, a first electrode, and a second electrode. The gate electrode of the first transistor T1 may be connected to a first node N1. The first transistor T1 may generate a driving current in response to a first gate signal and apply the current to the light-emitting diode LED. A first power voltage ELVDD may be applied to the first electrode of the first transistor T1. The first power voltage ELVDD may be a high power voltage. The second electrode of the first transistor T1 may be connected to a second node N2. The first transistor T1 may be referred to as a driving transistor. The first transistor T1 may be an NMOS transistor. However, embodiments of the present disclosure are not necessarily limited thereto.

The second transistor T2 may include a gate electrode, a first electrode, and a second electrode. The gate electrode of the second transistor T2 may be connected to one of the gate lines GL, and a second gate signal GW may be applied thereto. When the second transistor T2 is turned on in response to the second gate signal GW, the data voltage VDATA applied through one of the data lines DL may be applied to the gate electrode of the first transistor T1. The first electrode of the second transistor T2 may be connected to one of the data lines DL so that the data voltage is applied. The second electrode of the second transistor T2 may be connected to the first node N1. The second transistor T2 may be referred to as a writing transistor. The second transistor T2 may be an NMOS transistor. However, embodiments of the present disclosure are not necessarily limited thereto.

The third transistor T3 may include a gate electrode, a first electrode, and a second electrode. A third gate signal GR may be applied to the gate electrode of the third transistor T3. When the third transistor T3 is turned on by the third gate signal GR, a reference voltage VREF may be applied to the first node N1. The reference voltage VREF may be applied to the first electrode of the third transistor T3. The second electrode of the third transistor T3 may be connected to the first node N1. The third transistor T3 may be an NMOS transistor. However, embodiments of the present disclosure are not necessarily limited thereto.

The fourth transistor T4 may include a gate electrode, a first electrode, and a second electrode. A fourth gate signal GB may be applied to the gate electrode of the fourth transistor T4. When the fourth transistor T4 is turned on by the fourth gate signal GB, an initialization voltage VAINT may be applied to a third node N3. The initialization voltage VAINT may be applied to the first electrode of the fourth transistor T4. The second electrode of the fourth transistor T4 may be connected to the third node N3. The fourth transistor T4 may be an NMOS transistor. However, embodiments of the present disclosure are not necessarily limited thereto.

The fifth transistor T5 may include a gate electrode, a first electrode, and a second electrode. A fifth gate signal EM may be applied to the gate electrode of the fifth transistor T5. When the fifth transistor T5 is turned on by the fifth gate signal EM, the first power voltage ELVDD may be applied to the first electrode of the first transistor T1. The first power voltage ELVDD may be applied to the first electrode of the fifth transistor T5. The second electrode of the fifth transistor T5 may be connected to the first electrode of the first transistor T1. The fifth transistor T5 may be a PMOS transistor. However, embodiments of the present disclosure are not necessarily limited thereto.

The sixth transistor T6 may include a gate electrode, a first electrode, and a second electrode. A sixth gate signal EMB may be applied to the gate electrode of the sixth transistor T6. When the sixth transistor T6 is turned on by the sixth gate signal EMB, the first power voltage ELVDD may be applied to the first electrode of the light-emitting diode LED. The first electrode of the sixth transistor T6 may be connected to the second node N2. The second electrode of the sixth transistor T6 may be connected to the third node N3. The sixth transistor T6 may be a PMOS transistor. However, embodiments of the present disclosure are not necessarily limited thereto.

The first capacitor C1 may include a first electrode and a second electrode. The first power voltage ELVDD may be applied to the first electrode of the first capacitor C1. The second electrode of the first capacitor C1 may be connected to the second node N2. The first capacitor C1 may be referred to as a hold capacitor.

The second capacitor C2 may include a first electrode and a second electrode. The first electrode of the second capacitor C2 may be connected to the first node N1. The second electrode of the second capacitor C2 may be connected to the second node N2. The second capacitor C2 may be referred to as a storage capacitor.

The light-emitting diode LED may include a first electrode and a second electrode. The first electrode of the light-emitting diode LED may be connected to the third node N3. A second power voltage ELVSS may be applied to the second electrode of the light-emitting diode LED. The second power voltage ELVSS may be a low power voltage. The light-emitting diode LED may emit light with a luminance corresponding to the driving current applied from the first transistor T1.

As described above, the pixel PX is shown to have a 6T2C structure including six transistors and two capacitors, but embodiments of the present disclosure are not necessarily limited thereto. For example, according to embodiments, the pixel PX may include various configurations such as a 3T2C, 4T2C, or 7T2C structure.

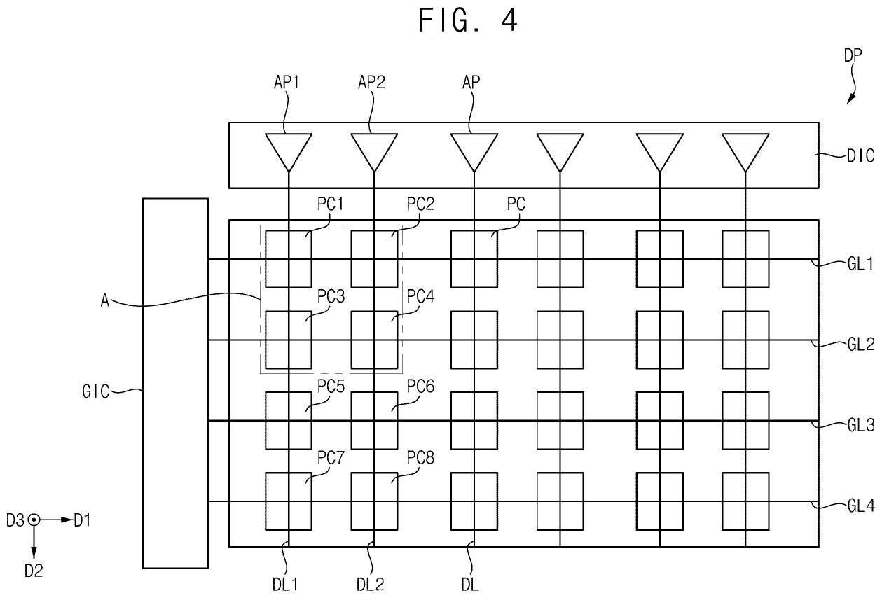

FIG. 4 is a plan view showing an embodiment of a pixel circuit portion disposed in the display panel of FIG. 2.

Referring to FIGS. 1, 2, 3, and 4, a plurality of pixel circuit portions PC may be disposed in the display area DA of the display panel DP. For example, as shown in FIG. 4, the pixel circuit portion PC may include first, second, third, fourth, fifth, sixth, seventh, and eighth pixel circuit portions PC1, PC2, PC3, PC4, PC5, PC6, PC7, and PC8. However, embodiments of the present disclosure are not necessarily limited thereto. The display panel DP may further include a plurality of pixel circuit portions along the first direction D1 and/or the second direction D2.

For example, the second pixel circuit portion PC2 may be spaced apart from the first pixel circuit portion PC1 in the first direction D1. The third pixel circuit portion PC3 may be spaced apart from the first pixel circuit portion PC1 in the second direction D2. The fourth pixel circuit portion PC4 may be spaced apart from the third pixel circuit portion PC3 in the first direction D1. The fifth pixel circuit portion PC5 may be spaced apart from the third pixel circuit portion PC3 in the second direction D2. The sixth pixel circuit portion PC6 may be spaced apart from the fifth pixel circuit portion PC5 in the first direction D1. The seventh pixel circuit portion PC7 may be spaced apart from the fifth pixel circuit portion PC5 in the second direction D2. The eighth pixel circuit portion PC8 may be spaced apart from the seventh pixel circuit portion PC7 in the first direction D1. However, embodiments of the present disclosure are not necessarily limited thereto.

Referring to the arrangement described above, in an embodiment, the plurality of pixel circuit portions PC1 to PC8 disposed along the first direction D1 and the second direction D2 may facilitate selective timing of gate driving across odd-numbered and even-numbered stages. By distributing the pixel circuit portions spatially in this manner, embodiments may effectively coordinate data voltage application according to color-specific driving of the light-emitting diodes, as will be described further below when the scan start signals are described in further detail. As a result, color data voltages may be applied in grouped sequences with reduced alternation, resulting in to improved power efficiency and simplified driving logic.

The data driver DIC may include first and second amplifiers AP1 and AP2. The first and second amplifiers AP1 and AP2 may be spaced apart from each other in the first direction D1. Each of the first and second amplifiers AP1 and AP2 may apply a data voltage to each of the pixel circuit portions PC. The first and second amplifiers AP1 and AP2 may apply the data voltage to first and second data lines DL1 and DL2 disposed in the display area DA, respectively.

In an embodiment, the first amplifier AP1 of the data driver DIC may apply the data voltage to the first pixel circuit portion PC1, the third pixel circuit portion PC3, the fifth pixel circuit portion PC5, and the seventh pixel circuit portion PC7 through the first data line DL1. The second amplifier AP2 of the data driver DIC may apply the data voltage to the second pixel circuit portion PC2, the fourth pixel circuit portion PC4, the sixth pixel circuit portion PC6, and the eighth pixel circuit portion PC8 through the second data line DL2.

The gate driver GIC may apply a gate voltage to first, second, third, and fourth gate lines GL1, GL2, GL3, and GL4 disposed in the display area DA.

Through this configuration, in an embodiment, the first amplifier AP1 and the second amplifier AP2 may be arranged to supply data voltages along separate data lines DL1 and DL2 that are connected to distinct subsets of pixel circuit portions. This arrangement may allow the data voltages associated with specific colors to be applied efficiently to pixel circuit portions connected to odd-numbered stages, and later to those connected to even-numbered stages, according to the scan sequence. Accordingly, redundant alternation of color data voltages across the data lines may be reduced, which may result in reduced power consumption.

In an embodiment, the gate driver GIC may apply a gate signal (e.g., the second gate signal GW of FIG. 2) to the first pixel circuit portion PC1 and the second pixel circuit portion PC2 through the first gate line GL1. The gate driver GIC may apply a gate signal (e.g., the second gate signal GW of FIG. 2) to the third pixel circuit portion PC3 and the fourth pixel circuit portion PC4 through the second gate line GL2. The gate driver GIC may apply a gate signal (e.g., the second gate signal GW of FIG. 2) to the fifth pixel circuit portion PC5 and the sixth pixel circuit portion PC6 through the third gate line GL3. The gate driver GIC may apply a gate signal (e.g., the second gate signal GW of FIG. 2) to the seventh pixel circuit portion PC7 and the eighth pixel circuit portion PC8 through the fourth gate line GL4.

In an embodiment, the above-described gate line arrangement also may also enable synchronized control of pixel circuit portions based on their assignment to either odd-numbered or even-numbered gate driver stages. For example, by sequencing the gate signals along GL1 to GL4 in conjunction with the scan start signals (described further below), the display device DD may apply data voltages for one color group during a first period while reserving other data voltages for a subsequent period, avoiding repeated toggling of the same data voltage during a single frame period. Such a driving sequence may improve operational efficiency and power consumption efficiency.

Referring to a comparative example, as the number of signals controlled by a plurality of amplifiers increases, power consumption used to drive the display device DD may increase. Embodiments of the present disclosure may address this issue by sequentially driving odd-numbered stages and even-numbered stages at different timings and applying data voltages to different pixel circuit portions associated with different colors, as described herein, which may reduce simultaneous signal load and improve power efficiency of the display device DD.

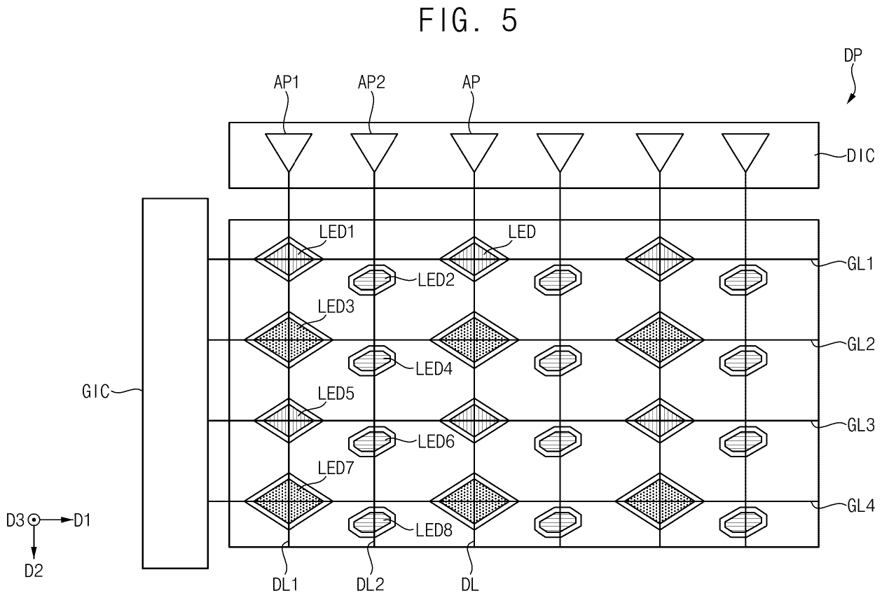

FIG. 5 is a plan view showing an embodiment of a light-emitting diode disposed in the display panel of FIG. 2.

Referring to FIGS. 1, 2, 3, and 5, the light-emitting diode LED may include first, second, third, fourth, fifth, sixth, seventh, and eighth light-emitting diodes LED1, LED2, LED3, LED4, LED5, LED6, LED7, and LED8. However, embodiments of the present disclosure are not necessarily limited thereto. In FIG. 5, the light-emitting diode LED is shown to include the first, second, third, fourth, fifth, sixth, seventh, and eighth light-emitting diodes LED1, LED2, LED3, LED4, LED5, LED6, LED7, and LED8, and the light-emitting diode LED may be repeatedly disposed along the first direction D1 and/or the second direction D2 (including additional light-emitting diodes LED not illustrated in FIG. 5).

As shown in FIG. 5, the first, second, third, fourth, fifth, sixth, seventh, and eighth light-emitting diodes LED1, LED2, LED3, LED4, LED5, LED6, LED7, and LED8 may be disposed in a Pentile matrix structure in a plan view. However, embodiments of the present disclosure are not necessarily limited thereto. The first, second, third, fourth, fifth, sixth, seventh, and eighth light-emitting diodes LED1, LED2, LED3, LED4, LED5, LED6, LED7, and LED8 may also be disposed in a diamond structure or a stripe structure.

For example, the second light-emitting diode LED2 may be spaced apart from the first light-emitting diode LED1 in the first direction D1. The third light-emitting diode LED3 may be spaced apart from the first light-emitting diode LED1 in the second direction D2. The fourth light-emitting diode LED4 may be spaced apart from the third light-emitting diode LED3 in the first direction D1. The fifth light-emitting diode LED5 may be spaced apart from the third light-emitting diode LED3 in the second direction D2. The sixth light-emitting diode LED6 may be spaced apart from the fifth light-emitting diode LED5 in the first direction D1. The seventh light-emitting diode LED7 may be spaced apart from the fifth light-emitting diode LED5 in the second direction D2. The eighth light-emitting diode LED8 may be spaced apart from the seventh light-emitting diode LED7 in the first direction D1. However, embodiments of the present disclosure are not necessarily limited thereto.

In an embodiment, the first light-emitting diode LED1 and the fifth light-emitting diode LED5 may emit red light. The third light-emitting diode LED3 and the seventh light-emitting diode LED7 may emit blue light. The second light-emitting diode LED2, the fourth light-emitting diode LED4, the sixth light-emitting diode LED6, and the eighth light-emitting diode LED8 may emit green light.

In an embodiment, the first light-emitting diode LED1 and the fifth light-emitting diode LED5 may emit blue light. The third light-emitting diode LED3 and the seventh light-emitting diode LED7 may emit red light. The second light-emitting diode LED2, the fourth light-emitting diode LED4, the sixth light-emitting diode LED6, and the eighth light-emitting diode LED8 may emit green light.

The selection and arrangement of the red, green, and blue light-emitting diodes in a Pentile, diamond, or stripe structure, according to embodiments, may further enable efficient grouping of the pixel circuit portions for color-specific driving. Because the pixel circuit portions are electrically connected to light-emitting diodes of particular colors, the scan driving sequence of the odd-numbered and even-numbered stages can be adapted to apply all data voltages for a first color, followed by those for another color. This targeted sequence may reduce the number of data voltage alternations, resulting in improved driving stability and power efficiency across high-resolution subpixel arrays.

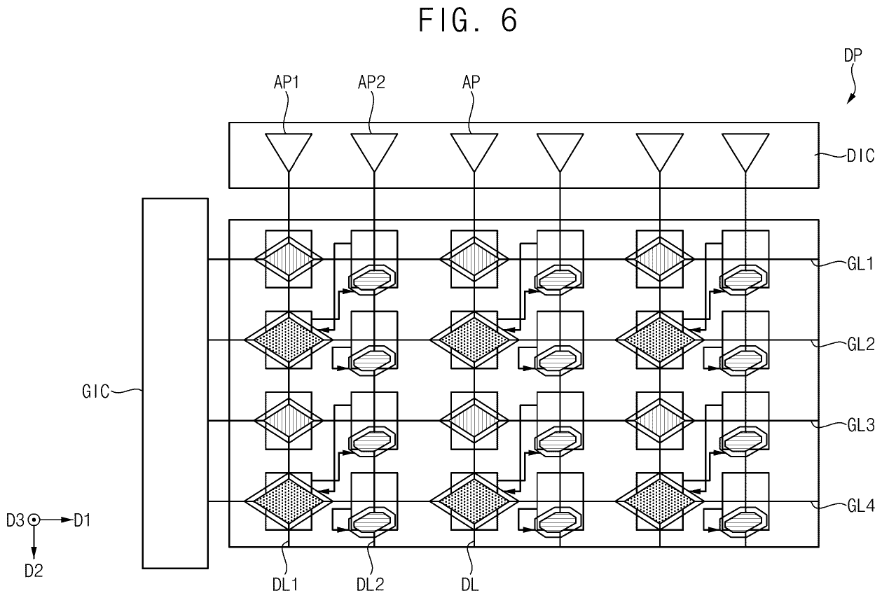

FIG. 6 is a plan view showing an embodiment in which the pixel circuit portion of FIG. 4 and the light-emitting diode of FIG. 5 are overlapped.

Referring to FIGS. 4, 5, and 6, the pixel circuit portion PC and the light-emitting diode LED may overlap in a plan view. For example, the first, second, third, fourth, fifth, sixth, seventh, and eighth pixel circuit portions PC1, PC2, PC3, PC4, PC5, PC6, PC7, and PC8 may respectively overlap the first, second, third, fourth, fifth, sixth, seventh, and eighth light-emitting diodes LED1, LED2, LED3, LED4, LED5, LED6, LED7, and LED8 in a plan view.

For example, the first light-emitting diode LED1 may overlap the first pixel circuit portion PC1 in a plan view, and the second light-emitting diode LED2 may overlap the second pixel circuit portion PC2 in a plan view.

In an embodiment, as shown in FIG. 6, the first pixel circuit portion PC1 may be electrically connected to the first light-emitting diode LED1. The second pixel circuit portion PC2 may be electrically connected to the third light-emitting diode LED3. The third pixel circuit portion PC3 may be electrically connected to the second light-emitting diode LED2. The fourth pixel circuit portion PC4 may be electrically connected to the fourth light-emitting diode LED4. The fifth pixel circuit portion PC5 may be electrically connected to the fifth light-emitting diode LED5. The sixth pixel circuit portion PC6 may be electrically connected to the seventh light-emitting diode LED7. The seventh pixel circuit portion PC7 may be electrically connected to the sixth light-emitting diode LED6. The eighth pixel circuit portion PC8 may be electrically connected to the eighth light-emitting diode LED8.

In an embodiment, the first light-emitting diode LED1 and the fifth light-emitting diode LED5 may emit red light, the third light-emitting diode LED3 and the seventh light-emitting diode LED7 may emit blue light, and the second light-emitting diode LED2, the fourth light-emitting diode LED4, the sixth light-emitting diode LED6, and the eighth light-emitting diode LED8 may emit green light. In this case, the first amplifier AP1 may apply a first data voltage for that drives emission of the red light-emitting diodes to the first pixel circuit portion PC1 and the fifth pixel circuit portion PC5, and may apply a second data voltage that drives emission of the green light-emitting diodes to the third pixel circuit portion PC3 and the seventh pixel circuit portion PC7.

With this arrangement, in an embodiment, the overlap of the pixel circuit portions and the light-emitting diodes may allow for color-specific electrical control to be coordinated precisely with the gate driver scan sequence. As odd-numbered stages and even-numbered stages are driven in succession, the color assignment to each light-emitting diode provides that data voltages for red, green, or blue emission can be grouped and applied in distinct scan periods. This may result in a reduction in switching events on the data lines and improve overall power efficiency.

In addition, the second amplifier AP2 may apply a third data voltage that drives emission of the blue light-emitting diodes to the second pixel circuit portion PC2 and the sixth pixel circuit portion PC6, and may apply the second data voltage that drives emission of the green light-emitting diodes to the fourth pixel circuit portion PC4 and the eighth pixel circuit portion PC8.

For example, the first amplifier AP1 may alternately apply the first data voltage and the second data voltage to the first data line DL1, and the second amplifier AP2 may alternately apply the second data voltage and the third data voltage to the second data line DL2.

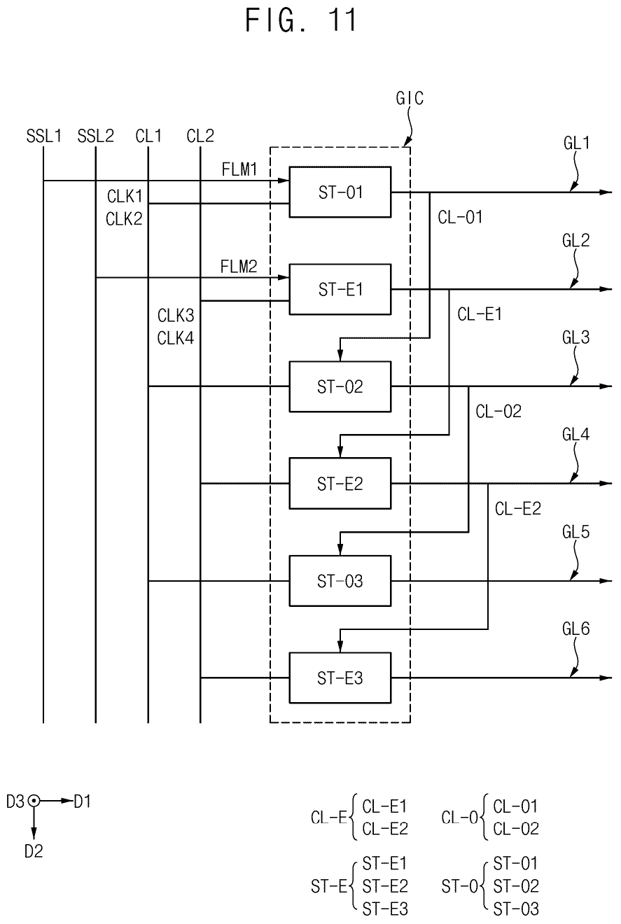

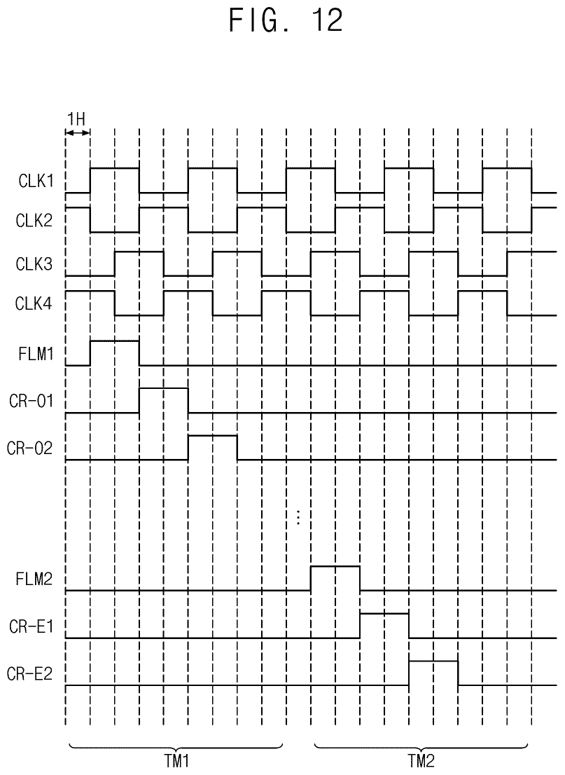

For example, the first data voltage may have a voltage of about 0.961 V to about 5.879 V. The second data voltage may have a voltage of about 0.938 V to about 5.941 V. The third data voltage may have a voltage of about 1.238 V to about 5.901 V. When each of the first amplifier AP1 and the second amplifier AP2 alternately applies the first, second, and third data voltages, a power consumption in the first amplifier AP1 and the second amplifier AP2 may increase. To solve the issue of increased power consumption, a driving method of the data driver DIC and the gate driver GIC that may improve power consumption efficiency will be described further below with reference to FIGS. 11 and 12.

The structure according to embodiments described above with reference to FIGS. 5, 6, and 7 may allow for the driving method that will be further described with reference to FIGS. 11 and 12, in which coordinated odd/even stage sequence is described in greater detail, which may result in improved data voltage control and reduced power consumption.

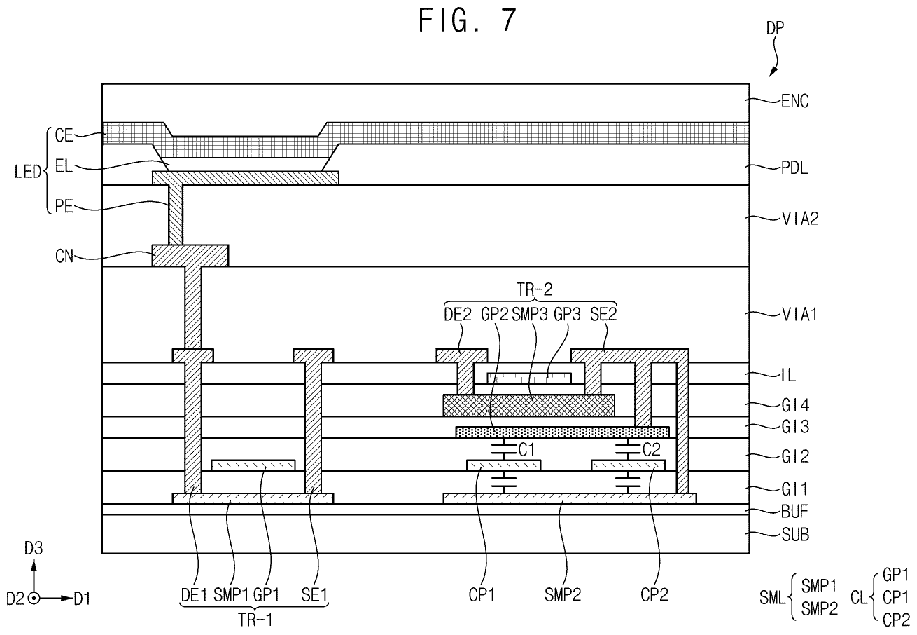

FIG. 7 is a cross-sectional view showing an embodiment of a display panel including the pixel circuit portion and the light-emitting diode of FIG. 6.

Referring to FIGS. 6 and 7, the display panel DP may include a substrate SUB, a buffer layer BUF, a first-type transistor TR-1, first, second, third, and fourth gate insulating layers GI1, GI2, GI3, and GI4, first and second conductive patterns CP1 and CP2, a second gate pattern GP2, a second-type transistor TR-2, an interlayer insulating layer IL, first and second via layers VIA1 and VIA2, a connection electrode CN, a light-emitting diode LED, and an encapsulation layer ENC.

The first-type transistor TR-1 may include a first semiconductor pattern SMP1, a first gate pattern GP1, a first source electrode SE1, and a first drain electrode DE1. For example, the first-type transistor TR-1 may be one of the fifth transistor T5 and the sixth transistor T6 shown in FIG. 2. The first-type transistor TR-1 may be a P-type transistor. However, embodiments of the present disclosure are not necessarily limited thereto.

The second-type transistor TR-2 may include a third semiconductor pattern SMP3, a second gate pattern GP2, a third gate pattern GP3, a second source electrode SE2, and a second drain electrode DE2. The second-type transistor TR-2 may be one of the first transistor T1, the second transistor T2, the third transistor T3, and the fourth transistor T4 shown in FIG. 2. The second-type transistor TR-2 may be an N-type transistor. However, embodiments of the present disclosure are not necessarily limited thereto.

The first semiconductor pattern SMP1, the first conductive pattern CP1, and the second conductive pattern CP2 may constitute a conductive layer CL. The light-emitting diode LED may include a pixel electrode PE, an emission layer EL, and a common electrode CE.

The substrate SUB may include, for example, a glass substrate, a metal substrate, a plastic substrate, etc. However, embodiments of the present disclosure are not necessarily limited thereto. For example, according to embodiments, the substrate SUB may be an inorganic layer, an organic layer, or a composite material layer.

The buffer layer BUF may be disposed on the substrate SUB. The buffer layer BUF may prevent impurities such as, for example, oxygen and moisture from penetrating to an upper portion of the substrate SUB. The buffer layer BUF may include an inorganic insulating material.

The first semiconductor pattern SMP1 and the second semiconductor pattern SMP2 may be disposed on the buffer layer BUF. The first semiconductor pattern SMP1 and the second semiconductor pattern SMP2 may be spaced apart from each other in a plan view. The first semiconductor pattern SMP1 and the second semiconductor pattern SMP2 may constitute a semiconductor layer SML.

Each of the first semiconductor pattern SMP1 and the second semiconductor pattern SMP2 may include, for example, an oxide semiconductor, a silicon semiconductor, an organic semiconductor, etc. For example, the oxide semiconductor may include at least one oxide of indium (In), gallium (Ga), tin (Sn), zirconium (Zr), vanadium (V), hafnium (Hf), cadmium (Cd), germanium (Ge), chromium (Cr), titanium (Ti), and zinc (Zn). The silicon semiconductor may include amorphous silicon, polycrystalline silicon, etc. The first semiconductor pattern SMP1 and the second semiconductor pattern SMP2 may include a source region, a drain region, and a channel region disposed between the source region and the drain region.

The first gate insulating layer GI1 may be disposed on the buffer layer BUF. For example, the first gate insulating layer GI1 may cover the semiconductor layer SML and be disposed on the buffer layer BUF. The first gate insulating layer GI1 may include an inorganic insulating material. In an embodiment, the first gate insulating layer GI1 may be entirely formed in the display area DA and the peripheral area SA.

The first gate pattern GP1, the first conductive pattern CP1, and the second conductive pattern CP2 may be disposed on the first gate insulating layer GI1. The first gate pattern GP1, the first conductive pattern CP1, and the second conductive pattern CP2 may be spaced apart from each other in a plan view. The first gate pattern GP1 may be a gate electrode of the first-type transistor TR-1. The first gate pattern GP1 may at least partially overlap the channel region of the first semiconductor pattern SMP1 in a plan view. The first conductive pattern CP1 may form the first capacitor C1 with the second semiconductor pattern SMP2. The second conductive pattern CP2 may form the second capacitor C2 with the second semiconductor pattern SMP2.

For example, each of the first gate pattern GP1, the first conductive pattern CP1, and the second conductive pattern CP2 may include a conductive material such as metal, alloy, conductive metal nitride, conductive metal oxide, or transparent conductive material. Examples of the conductive material that may be used for the gate electrode GE may include gold (Au), silver (Ag), aluminum (Al), platinum (Pt), nickel (Ni), titanium (Ti), palladium (Pd), magnesium (Mg), calcium (Ca), lithium (Li), chromium (Cr), tantalum (Ta), tungsten (W), copper (Cu), molybdenum (Mo), scandium (Sc), neodymium (Nd), iridium (Ir), aluminum-containing alloy, silver-containing alloy, copper-containing alloy, molybdenum-containing alloy, aluminum nitride (AlN), tungsten nitride (WN), titanium nitride (TiN), chromium nitride (CrN), tantalum nitride (TaN), strontium ruthenium oxide (SrRuO), zinc oxide (ZnO), indium tin oxide (ITO), tin oxide (SnO), indium oxide (InO), gallium oxide (GaO), indium zinc oxide (IZO), etc. These may be used alone or in combination with each other. However, embodiments of the present disclosure are not necessarily limited thereto.

The second gate insulating layer GI2 may be disposed on the first gate insulating layer GI1. For example, the second gate insulating layer GI2 may cover each of the first gate pattern GP1, the first conductive pattern CP1, and the second conductive pattern CP2, and may be disposed on the first gate insulating layer GI1. The second gate insulating layer GI2 may include substantially a same material as the first gate insulating layer GI1.

The second gate pattern GP2 may be disposed on the second gate insulating layer GI2. The second gate pattern GP2 may overlap the first conductive pattern CP1 and the second conductive pattern CP2 in a plan view. Accordingly, the second gate pattern GP2 may form the first capacitor C1 with the first conductive pattern CP1, and the second capacitor C2 with the second conductive pattern CP2. The second gate pattern GP2 may be a back gate electrode of the second-type transistor TR-2.

In an embodiment, the configuration of the gate patterns GP1 and GP2, the conductive patterns CP1 and CP2, and their associated capacitor structures C1 and C2, as described above, may support precise pixel circuit operation during scan driving. For example, these elements may enable stable storage and transfer of the data voltages applied by the data driver when coordinating the application of data voltages according to odd-numbered and even-numbered gate driver stages. This arrangement may provide consistent emission control while reducing redundant data voltage alternation across the display device DD.

The third gate insulating layer GI3 may be disposed on the second gate insulating layer GI2. For example, the third gate insulating layer GI3 may cover the second gate pattern GP2 and be disposed on the second gate insulating layer GI2. The third gate insulating layer GI3 may include substantially a same material as the first gate insulating layer GI1.

The third semiconductor pattern SMP3 may be disposed on the third gate insulating layer GI3. The third semiconductor pattern SMP3 may include a source region, a drain region, and a channel region disposed between the source region and the drain region. The channel region of the third semiconductor pattern SMP3 may at least partially overlap the second gate pattern GP2 in a plan view. The third semiconductor pattern SMP3 may include, for example, an oxide semiconductor, a silicon semiconductor, an organic semiconductor, etc. For example, the oxide semiconductor may include at least one oxide of indium (In), gallium (Ga), tin (Sn), zirconium (Zr), vanadium (V), hafnium (Hf), cadmium (Cd), germanium (Ge), chromium (Cr), titanium (Ti), and zinc (Zn). The silicon semiconductor may include amorphous silicon, polycrystalline silicon, etc.

The fourth gate insulating layer GI4 may be disposed on the third gate insulating layer GI3. For example, the fourth gate insulating layer GI4 may cover the third semiconductor pattern SMP3 and be disposed on the third gate insulating layer GI3. The fourth gate insulating layer GI4 may include substantially a same material as the first gate insulating layer GI1.

The third gate pattern GP3 may be disposed on the fourth gate insulating layer GI4. The third gate pattern GP3 may at least partially overlap the channel region of the third semiconductor pattern SMP3 in a plan view. The third gate pattern GP3 may be a gate electrode of the second-type transistor TR-2. The third gate pattern GP3 may include substantially a same material as the first gate pattern GP1.

The interlayer insulating layer IL may be disposed on the fourth gate insulating layer GI4. For example, the interlayer insulating layer IL may cover the third gate pattern GP3 and be disposed on the fourth gate insulating layer GI4. For example, the interlayer insulating layer IL may include substantially a same material as the first gate insulating layer GI1.

The first drain electrode DE1, the first source electrode SE1, the second drain electrode DE2, and the second source electrode SE2 may be disposed on the interlayer insulating layer IL.

The first drain electrode DE1 may be in contact (e.g., direct contact) with the drain region of the first semiconductor pattern SMP1, and the first source electrode SE1 may be in contact (e.g., direct contact) with the source region of the first semiconductor pattern SMP1. The second drain electrode DE2 may be in contact (e.g., direct contact) with the drain region of the third semiconductor pattern SMP3. The second source electrode SE2 may be in contact (e.g., direct contact) with the source region of the third semiconductor pattern SMP3, the second gate pattern GP2, and the second conductive pattern CP2.

The first via layer VIA1 may be disposed on the interlayer insulating layer IL. For example, the first via layer VIA1 may cover the first drain electrode DE1, the first source electrode SE1, the second drain electrode DE2, and the second source electrode SE2, and be disposed on the interlayer insulating layer IL. The first via layer VIA1 may include an organic insulating material. In an embodiment, the first via layer VIA1 may be formed only in the display area DA and a portion of the peripheral area SA adjacent to the display area DA.

The connection electrode CN may be disposed on the first via layer VIA1. The connection electrode CN may apply a signal transmitted from the first-type transistor TR-1 to the light-emitting diode LED. The connection electrode CN may include, for example, metal, alloy, metal nitride, conductive metal oxide, or transparent conductive material. These may be used alone or in combination with each other. However, embodiments of the present disclosure are not necessarily limited thereto.

The second via layer VIA2 may be disposed on the connection electrode CN. For example, the second via layer VIA2 may be disposed on the first via layer VIA1 and may cover the connection electrode CN. The second via layer VIA2 may include substantially a same material as the first via layer VIA1.

The pixel electrode PE may be disposed on the second via layer VIA2. The pixel electrode PE may include a conductive material. The pixel electrode PE may be connected to the drain electrode DE through the connection electrode CN. Accordingly, the pixel electrode PE may be electrically connected to the transistor TR.

A pixel define layer PDL may be disposed on the pixel electrode PE. For example, the pixel define layer PDL may expose at least a portion of the pixel electrode PE. The pixel define layer PDL may include an inorganic insulating material or an organic insulating material.

The emission layer EL may be disposed on the pixel electrode PE. In an embodiment, the emission layer EL may be disposed in an opening defined by the pixel define layer PDL. For example, the emission layer EL may be surrounded by the pixel define layer PDL. In an embodiment, the emission layer EL may also be disposed on the pixel define layer PDL. The emission layer EL may include at least one of an organic light-emitting material and a quantum dot. However, embodiments of the present disclosure are not necessarily limited thereto.

The common electrode CE may be disposed on the emission layer EL. The common electrode CE may also be disposed on the pixel define layer PDL. For example, the common electrode CE may be continuously disposed on the emission layer EL and the pixel define layer PDL. The common electrode CE may include a conductive material. The emission layer EL may emit light based on a voltage difference between the pixel electrode PE and the common electrode CE.

The encapsulation layer ENC may cover an upper surface of the common electrode CE. The encapsulation layer ENC may include at least one organic encapsulation layer and at least one inorganic encapsulation layer. In an embodiment, the organic encapsulation layer and the inorganic encapsulation layer may be alternately stacked. For example, the organic encapsulation layer may include a polymer cured material such as polyacrylate, epoxy resin, or silicone resin. For example, the inorganic encapsulation layer may include silicon oxide, silicon nitride, silicon carbide, aluminum oxide, tantalum oxide, hafnium oxide, zirconium oxide, titanium oxide, etc.

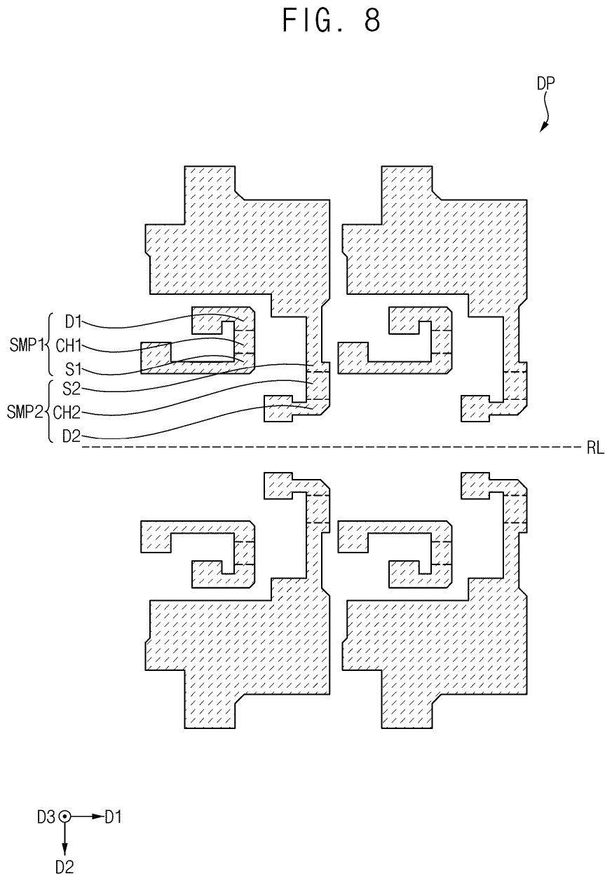

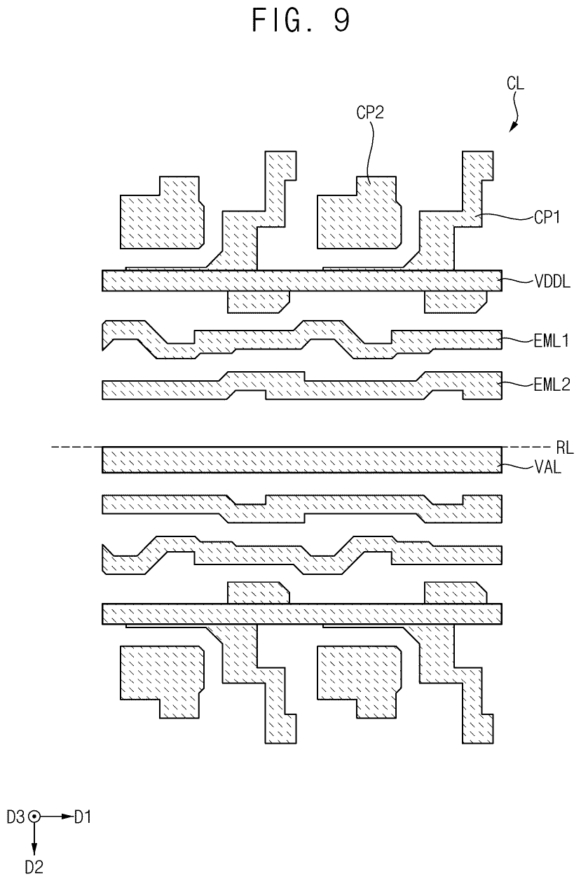

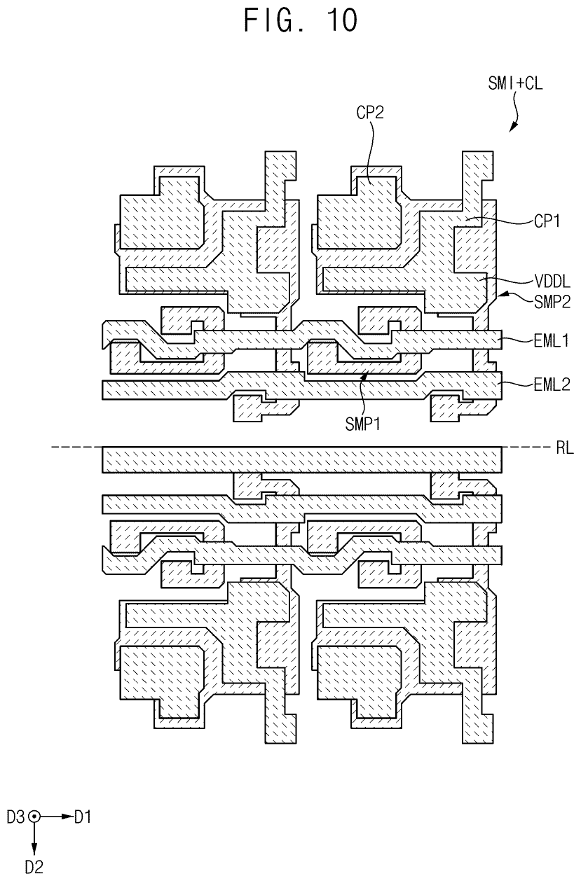

FIG. 8 is a plan view showing an embodiment of a semiconductor layer included in FIG. 7. FIG. 9 is a plan view showing an embodiment of a conductive layer included in FIG. 7. FIG. 10 is a plan view showing an overlap of the semiconductor layer of FIG. 8 and the conductive layer of FIG. 9.

For example, the plan views shown in FIGS. 8, 9, and 10 are enlarged views of the area A of FIG. 4.

Referring to FIGS. 4, 7, and 8, the plurality of semiconductor layers SML may include a first semiconductor pattern SMP1 and a second semiconductor pattern SMP2. The first semiconductor pattern SMP1 and the second semiconductor pattern SMP2 may be disposed in a repeated pattern in the first direction D1. Accordingly, each of the pixel circuit portions PC may include one first semiconductor pattern SMP1 and one second semiconductor pattern SMP2.

In an embodiment, the semiconductor layer SML may be symmetrical about a virtual reference line RL extending in the first direction D1. For example, the semiconductor layer SML of the first pixel circuit portion PC1 may be symmetrical with the semiconductor layer SML of the third pixel circuit portion PC3 about the reference line RL in a plan view. The semiconductor layer SML of the second pixel circuit portion PC2 may be symmetrical with the semiconductor layer SML of the fourth pixel circuit portion PC4 about the reference line RL in a plan view.

As the semiconductor layer SML has a symmetrical shape with respect to the reference line RL, the semiconductor layer SML may be efficiently disposed in a plan view compared to an asymmetric case. Accordingly, the semiconductor layer SML may be efficiently arranged in a plan view, and as a result, the display device (e.g., the display device DD of FIG. 1) may be implemented as a high-resolution pixel structure.

However, although the semiconductor layer SML may be symmetrical about the reference line RL extending in the first direction D1, in an embodiment, the semiconductor layer SML is not symmetrical about a virtual line extending in the second direction D2. Accordingly, the semiconductor layer SML may have a repeated pattern shape along the first direction D1 in a plan view.

The symmetrical arrangement of the semiconductor layers with respect to the reference line RL, in embodiments as described above, may contribute to uniform propagation of control signals along the gate lines and data lines. This can improve the stability of the pixel circuit operation when applying scan start signals for odd-numbered and even-numbered gate driver stages, which may support reliable data voltage control with reduced alternation.

Each of the first semiconductor patterns SMP1 may include a first source region, a first drain region, and a first channel region disposed between the first source region and the first drain region. Each of the second semiconductor patterns SMP2 may include a second source region, a second drain region, and a second channel region disposed between the second source region and the second drain region.

Referring to FIGS. 4, 7, and 9, the conductive layer CL may include the first conductive pattern CP1, the second conductive pattern CP2, a power voltage line VDDL, a first emission line EML1, a second emission line EML2, and an initialization voltage line VAL.

The power voltage line VDDL may apply the first power voltage (e.g., the first power voltage ELVDD of FIG. 3). The first emission line EML1 may apply the fifth gate signal (e.g., the fifth gate signal EM of FIG. 3). The second emission line EML2 may apply the sixth gate signal (e.g., the sixth gate signal EMB of FIG. 3).

The power voltage line VDDL may contact the first conductive pattern CP1. Accordingly, the first power voltage (e.g., the first power voltage ELVDD of FIG. 3) may be applied to the first conductive pattern CP1.

In an embodiment, the conductive pattern CP may be symmetrical with respect to the reference line RL in a plan view. Accordingly, the first conductive pattern CP1 and the second conductive pattern CP2 included in the first pixel circuit portion PC1 may be symmetrical with the first conductive pattern CP1 and the second conductive pattern CP2 included in the third pixel circuit portion PC3.

The first pixel circuit portion PC1 and the third pixel circuit portion PC3 may share the initialization voltage line VAL. The second pixel circuit portion PC2 and the fourth pixel circuit portion PC4 may share the initialization voltage line VAL. Accordingly, the initialization voltage line VAL may be disposed to at least partially overlap the reference line RL in a plan view. However, embodiments of the present disclosure are not necessarily limited thereto.

Referring to FIGS. 7, 8, 9, and 10, the semiconductor layer SML and the conductive layer CL may at least partially overlap in a plan view.

The first conductive pattern CP1 may overlap the second semiconductor pattern SMP2 in a plan view. The first conductive pattern CP1 and the second semiconductor pattern SMP2 may form the first capacitor C1.

The second conductive pattern CP2 may overlap the second semiconductor pattern SMP2 in a plan view. The second conductive pattern CP2 and the second semiconductor pattern SMP2 may form the second capacitor C2.

The first emission line EML1 may overlap the channel region of the first semiconductor layer SML in a plan view. The first emission line EML1 may be a gate electrode of the first semiconductor layer SML. For example, the first emission line EML1 may be the first gate pattern GP1 of FIG. 7.

The second emission line EML2 may overlap the channel region of the second semiconductor layer SML in a plan view. The second emission line EML2 may be a gate electrode of the second semiconductor layer SML. For example, the second emission line EML2 may be the first gate pattern GP1 of FIG. 7.

According to embodiments, the overlap of the semiconductor layer SML with the conductive layer CL described above may cause the data voltages to be maintained uniformly across the pixel circuit portions. By stabilizing the positions of capacitors and emission lines, the pixel circuits can reliably store and transfer data voltages during the coordinated odd/even stage scan driving sequence, which may improve efficiency and color uniformity in the display.

FIG. 11 is a plan view showing an embodiment of the gate driver of FIG. 2.

Referring to FIGS. 2, 6, and 11, the gate driver GIC may include odd-numbered stages ST-O and even-numbered stages ST-E. The odd-numbered stages ST-O may include a first odd-numbered stage ST-O1, a second odd-numbered stage ST-O2, and a third odd-numbered stage ST-O3. The even-numbered stages ST-E may include a first even-numbered stage ST-E1, a second even-numbered stage ST-E2, and a third even-numbered stage ST-E3.

In an embodiment, the odd-numbered stages ST-O and the even-numbered stages ST-E may be alternately disposed in the second direction D2. For example, the first even-numbered stage ST-E1 may be spaced apart from the first odd-numbered stage ST-O1 in the second direction D2. The second odd-numbered stage ST-O2 may be spaced apart from the first even-numbered stage ST-E1 in the second direction D2.

The alternating arrangement of the odd-numbered stages ST-O and the even-numbered stages ST-E according to an embodiment, as described above, may support the coordinated driving of gate lines so that data voltages for one color group can be applied during a first timing, while data voltages for another color group can be applied during a second timing. This may reduce the frequency of alternating data voltages and contribute to maintaining consistent pixel circuit operation across the display area DA.

Each of the odd-numbered stages ST-O and the even-numbered stages ST-E may be connected in a one-to-one correspondence with the gate lines (e.g., the gate lines GL of FIG. 2) and may apply gate signals (e.g., the second gate signal GW of FIG. 3).

For example, the first odd-numbered stage ST-O1 may be connected to the first gate line GL1. The first even-numbered stage ST-E1 may be connected to the second gate line GL2. The second odd-numbered stage ST-O2 may be connected to the third gate line GL3. The second even-numbered stage ST-E2 may be connected to the fourth gate line GL4. The third odd-numbered stage ST-O3 may be connected to the fifth gate line GL5. The third even-numbered stage ST-E3 may be connected to the sixth gate line GL6.

The display device DD may further include a first scan start line SSL1 and a second scan start line SSL2. The first scan start line SSL1 may drive the first odd-numbered stage ST-O1 among the odd-numbered stages ST-O, and the second scan start line SSL2 may drive the first even-numbered stage ST-E1 among the even-numbered stages ST-E. For example, the first odd-numbered stage ST-O1 among the odd-numbered stages ST-O may be driven by the first scan start line SSL1 and generate a writing signal, and the first even-numbered stage ST-E1 among the even-numbered stages ST-E may be driven by the second scan start line SSL2 and generate a writing signal.

The odd-numbered stages ST-O may generate a writing signal based on a first clock signal CLK1 and a second clock signal CLK2 applied through the first clock signal line CL1. The even-numbered stages ST-E may generate a writing signal based on a third clock signal CLK3 and a fourth clock signal CLK4 applied through the second clock signal line CL2.

In an embodiment, the odd-numbered stages ST-O may be connected by an odd carry line CL-O, and the even-numbered stages ST-E may be connected by an even carry line CL-E.

For example, a first odd carry line CL-O1 extending from the first odd-numbered stage ST-O1 may drive the second odd-numbered stage ST-O2. An output signal generated by the second odd-numbered stage ST-O2 may be applied to the third odd-numbered stage ST-O3 via a second odd carry line CL-O2.

In an embodiment, a first even carry line CL-E1 extending from the first even-numbered stage ST-E1 may drive the second even-numbered stage ST-E2. An output signal generated by the second even-numbered stage ST-E2 may be applied to the third even-numbered stage ST-E3 via a second even carry line CL-E2.

In this configuration, in an embodiment, the odd carry lines CL-O and the even carry lines CL-E may propagate scan signals through their respective stage groups in a controlled sequence. This propagation may support the systematic application of writing signals to the pixel circuit portions, allowing for color data voltages to be grouped and applied in separate timing periods, which may result in improved power efficiency and reduced switching noise on the data lines.

FIG. 12 is a timing diagram showing a method of driving the gate driver of FIG. 11.

Referring to FIGS. 11 and 12, the odd-numbered stages ST-O may generate writing signals based on the first clock signal CLK1 and the second clock signal CLK2, which have a duration of two horizontal periods. The even-numbered stages ST-E may generate writing signals based on the third clock signal CLK3 and the fourth clock signal CLK4, which have a duration of two horizontal periods.

In an embodiment, the first odd-numbered stage ST-O1 may be driven by a first scan start signal FLM1 transmitted through the first scan start line SSL1. The first odd-numbered stage ST-O1 driven by the first scan start signal FLM1 may apply a first odd carry signal CRO-1 to the first odd carry line CL-O1. The first odd carry signal CRO-1 may drive the second odd-numbered stage ST-O2, and the second odd-numbered stage ST-O2 may apply a second odd carry signal CRO-2 to the second odd carry line CL-O2. The timing at which all of the odd-numbered stages ST-O are driven may be referred to as a first timing TM1.

After all of the odd-numbered stages ST-O are driven during the first timing TM1, the even-numbered stages ST-E may be sequentially driven by a second scan signal FLM2.

The first even-numbered stage ST-E1 may be driven by a second scan start signal FLM2 transmitted through the second scan start line SSL2. The first even-numbered stage ST-E1 driven by the second scan start signal FLM2 may apply a first even carry signal CR-E1 to the first even carry line CL-E1. The first even carry signal CR-E1 may drive the second even-numbered stage ST-E2, and the second even-numbered stage ST-E2 may apply a second even carry signal CR-E2 to the second even carry line CL-E2. The timing at which all of the even-numbered stages ST-E are driven may be referred to as a second timing TM2.

A sum of the first timing TM1 and the second timing TM2 may correspond to one frame of an image signal emitted by the display device DD. The one frame may have a refresh rate of, for example, about 60 Hz, about 120 Hz, or about 240 Hz. However, embodiments of the present disclosure are not necessarily limited thereto.

Upon review, the pixel circuit portions PC connected to the odd-numbered stages ST-O and the pixel circuit portions PC connected to the even-numbered stages ST-E may be driven at different timings. Accordingly, when alternately applying the data voltage to the first pixel circuit portion PC1 to control a first color and the third pixel circuit portion PC3 to control a third color, the first data voltage corresponding to the first color may be fully applied before the third data voltage corresponding to the third color is applied. Similarly, when alternately applying the data voltage to the second pixel circuit portion PC2 to control a second color and the fourth pixel circuit portion PC4 t control a third color, the second data voltage corresponding to the second color may be fully applied before the third data voltage corresponding to the third color is applied.

For example, by driving the pixel circuit portions PC connected to the odd-numbered stages ST-O and the pixel circuit portions PC connected to the even-numbered stages ST-E at different timings, the number of times the data voltage is alternately applied may be reduced. As a result, power consumption in the display device DD may be reduced, which may improve power efficiency of the display device DD.

By coordinating the timing of odd-numbered and even-numbered gate driver stages, the display device DD according to embodiments of the present disclosure can better accommodate high-resolution color subpixel patterns, such as those in, for example, a Pentile or diamond arrangement, while maintaining low power consumption. This driving method may result in stable and uniform color reproduction in high-definition display panels.

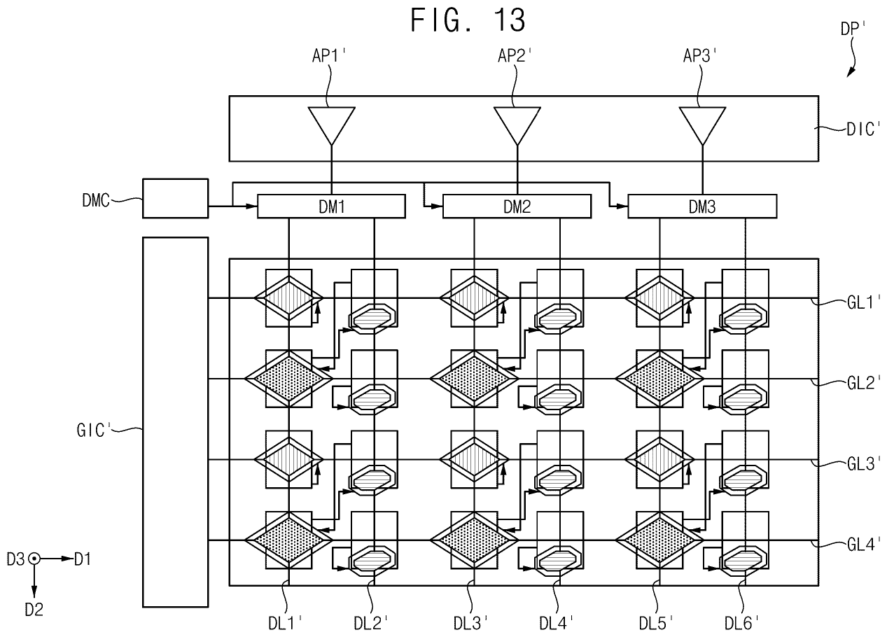

FIG. 13 is a plan view showing an embodiment in which the pixel circuit portion and the light-emitting diode of FIGS. 4 and 5 are overlapped. For example, the display panel DP shown in FIG. 13 may be same as the display panel DP shown in FIG. 6, except for a demultiplexer controller DMC and demultiplexers. Therefore, for convenience of explanation, redundant descriptions may be omitted or simplified, and apostrophes may be used after certain reference characters to indicate similar elements previously described.

Referring to FIGS. 4 to 6 and 13, the display panel DP′ of FIG. 13 may further include the demultiplexer controller DMC and the demultiplexers in addition to the display panel DP of FIG. 6. The demultiplexers may include first, second, and third demultiplexers DM1, DM2, and DM3.

The first, second, and third demultiplexers DM1, DM2, and DM3 may be spaced apart from the data driver DIC′ in the second direction D2 in a plan view. The first, second, and third demultiplexers DM1, DM2, and DM3 may be disposed in parallel in the second direction D2. Signals transmitted from the first, second, and third amplifiers AP1′, AP2′, and AP3′ may be branched into two data lines and applied by the first, second, and third demultiplexers DM1, DM2, and DM3. For example, the first demultiplexer DM1 may receive a data signal from the first amplifier AP1′ and alternately transmit the data signal to first and second data lines DL1′ and DL2′.

In an embodiment, the first demultiplexer DM1 may be connected to the first amplifier AP1′ and electrically connected to the first data line DL1′ and the second data line DL2′.

The demultiplexer controller DMC may control the first, second, and third demultiplexers DM1, DM2, and DM3.

The use of the demultiplexer controller DMC in combination with the demultiplexers DM1, DM2, and DM3 in an embodiment may facilitate the distribution of data voltages to multiple data lines while reducing the number of amplifiers. By branching data voltages to selected pixel circuit portions in an organized sequence, the display panel can coordinate the application of color-specific data voltages in line with the odd-numbered and even-numbered scan driving techniques described above. As a result, the overall power efficiency and data voltage stability of the display device may be improved.

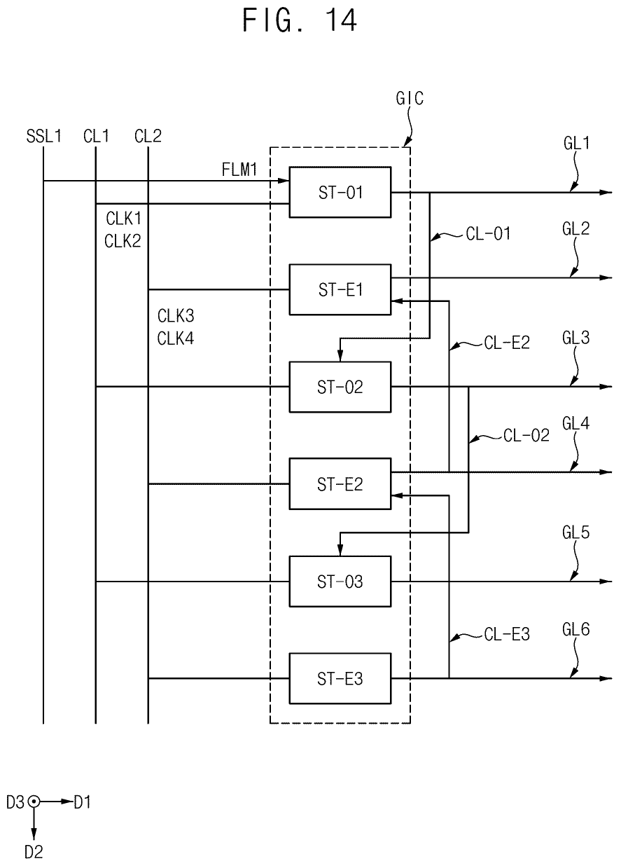

FIG. 14 is a plan view showing an embodiment of the gate driver of FIG. 2. For example, FIG. 14 may be substantially the same as FIG. 11 except for the connection of the even carry line CL-E and an absence of the second scan start line SSL2. Therefore, for convenience of explanation, redundant descriptions may be omitted or simplified.

Referring to FIGS. 2, 13, and 14, the display device DD may include a first scan start line SSL1. The first scan start line SSL1 may drive the first odd-numbered stage ST-O1 among the odd-numbered stages ST-O. For example, the first odd-numbered stage ST-O1 among the odd-numbered stages ST-O may be driven by the first scan start line SSL1 and generate a writing signal.

In an embodiment, the odd-numbered stages ST-O may be connected to each other by the odd carry line CL-O. For example, a first odd carry line CL-O1 extending from the first odd-numbered stage ST-O1 may drive the second odd-numbered stage ST-O2. An output signal generated by the second odd-numbered stage ST-O2 may be applied to the third odd-numbered stage ST-O3 through a second odd carry line CL-O2. As described above, the odd-numbered stages ST-O may be driven in ascending order. Accordingly, after the last odd-numbered stage among the odd-numbered stages ST-O is driven, the last odd-numbered stage may drive the last even-numbered stage.

The last even-numbered stage may sequentially drive the even-numbered stages ST-E in descending order. Accordingly, a third even carry line CL-E3 extending from the third even-numbered stage ST-E3 may drive the second even-numbered stage ST-E2 through a third even carry signal CR-E3. The second even-numbered stage ST-E2 may drive the first even-numbered stage ST-E1 through a second even carry signal CR-E2.

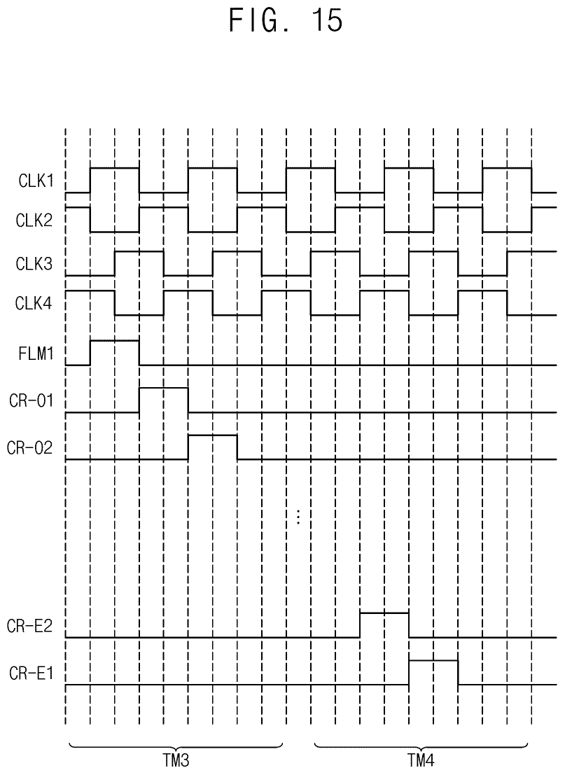

FIG. 15 is a timing diagram showing a method of driving the gate driver of FIG. 14.

Referring to FIGS. 14 and 15, the odd-numbered stages ST-O may generate writing signals based on the first clock signal CLK1 and the second clock signal CLK2, which have a duration of two horizontal periods. The even-numbered stages ST-E may generate writing signals based on the third clock signal CLK3 and the fourth clock signal CLK4, which have a duration of two horizontal periods.

In an embodiment, the first odd-numbered stage ST-O1 may be driven by a first scan start signal FLM1 transmitted through the first scan start line SSL1. The first odd-numbered stage ST-O1 driven by the first scan start signal FLM1 may apply a first odd carry signal CRO-1 to the first odd carry line CL-O1. The first odd carry signal CRO-1 may drive the second odd-numbered stage ST-O2, and the second odd-numbered stage ST-O2 may apply a second odd carry signal CRO-2 to the second odd carry line CL-O2. A timing at which all of the odd-numbered stages ST-O are driven may be referred to as a third timing TM3.

After the third timing TM3 ends, the last odd-numbered stage may drive the last even-numbered stage. For example, a carry signal generated by the last odd-numbered stage may drive the last even-numbered stage. The even-numbered stages ST-E may be driven in descending order. The timing at which all of the even-numbered stages ST-E shown in FIGS. 14 and 15 are driven may be referred to as a fourth timing TM4.

A sum of the third timing TM3 and the fourth timing TM4 may correspond to one frame of a signal emitted by the display device DD. The one frame may have a refresh rate of, for example, about 60 Hz, about 120 Hz, or about 240 Hz. However, embodiments of the present disclosure are not necessarily limited thereto.

In an embodiment, the use of the third timing TM3 and the fourth timing TM4 may allow the display device DD to reliably apply data voltages to color subpixels in a consistent pattern, which may reduce voltage fluctuation and improve the uniformity of color emission across the display device DD. As a result, the driving method according to an embodiment may support high-resolution, low-power display devices with stable color performance.

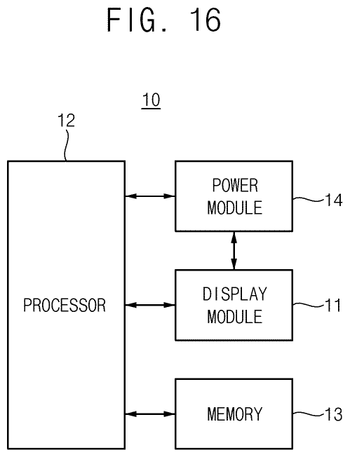

FIG. 16 is a block diagram showing an electronic device according to an embodiment of the present disclosure.

Referring to FIGS. 1 and 16, the display device DD according to embodiments of the disclosure may be applied to various electronic devices 10. An electronic device 10 according to an embodiment may include the display device DD and additional modules or devices providing other functionalities.

The electronic device 10 may include a display module 11, a processor 12, a memory 13, and a power module 14.

The processor 12 may include at least one of, for example, a central processing unit (CPU), an application processor (AP), a graphics processing unit (GPU), a communication processor (CP), an image signal processor (ISP), and a controller.

The memory 13 may store data and information utilized for an operation of the processor 12 or the display module 11. When the processor 12 executes an application stored in the memory 13, video data signals and/or input control signals may be transmitted to the display module 11. The display module 11 may process the received signals to output video information on the display screen.

The power module 14 may include a power adapter, a battery device, and a power conversion module, and may generate the power utilized for operation of the electronic device 10.

At least one component of the electronic device 10 described above may be included in the display device DD according to embodiments of the present disclosure. Some individual components functionally included in a module may be integrated into the display device DD, while others may be provided separately from the display device DD. For example, the display device DD may include the display module 11, while the processor 12, the memory 13, and the power module 14 may be provided as separate devices within the electronic device 10.

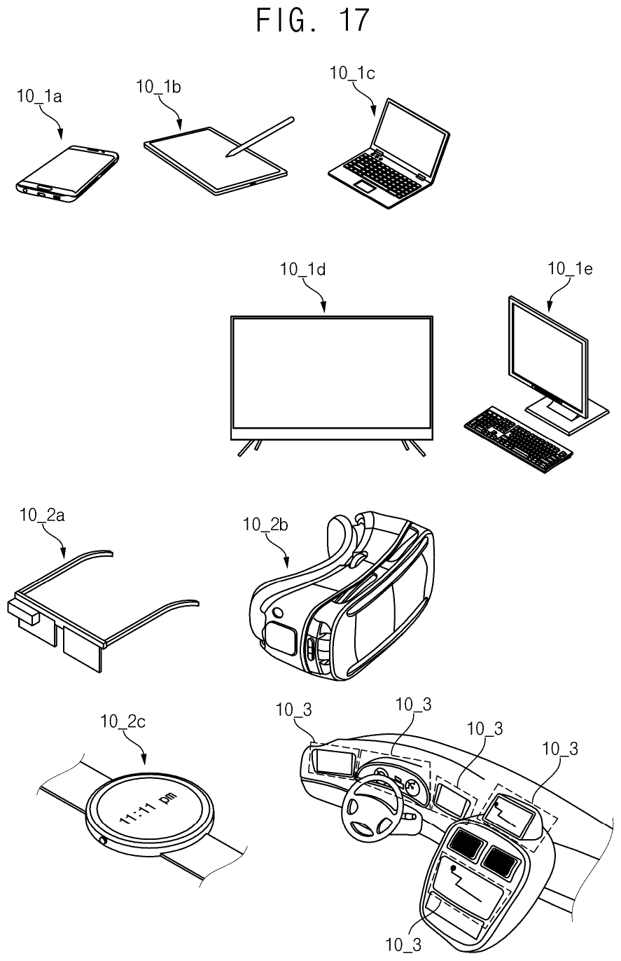

FIG. 17 illustrates various embodiments of the electronic device of FIG. 16.

Referring to FIGS. 16 and 17, various electronic devices 10 incorporating the display device DD may include image-display electronic devices such as, for example, smartphones 10_1a, tablet computers 10_1b, laptops 10_1c, TVs 10_1d, and computer monitors 10_1e. In addition, wearable electronic devices including display modules such as, for example, smart glasses 10_2a, head-mounted displays 10_2b, and smartwatches 10_2c, and vehicle electronic devices including display modules such as, for example, instrument clusters, center information displays (CID), and mirrors of the vehicle, may also be included.

However, these examples are illustrative, and the electronic device 10 according to embodiments of the present disclosure is not necessarily limited thereto. For example, the electronic device 10 may be implemented as a mobile phone, videophone, smart pad, smartwatch, tablet PC, vehicle display, computer monitor, laptop, or head-mounted display device. In addition, the electronic device 10 may be, for example, a television, monitor, laptop computer, or tablet. Furthermore, the electronic device 10 may also be a vehicle.

While the present disclosure has been particularly shown and described with reference to embodiments thereof, it will be understood by those of ordinary skill in the art that various changes in form and detail may be made therein without departing from the spirit or scope of the present disclosure as defined by the following claims.

What is claimed is:

1. A display device, comprising:
a display panel including a display area and a peripheral area surrounding at least a portion of the display area;
a gate driver disposed in the peripheral area and including odd-numbered stages and even-numbered stages;
a first scan start signal line disposed in the peripheral area and configured to apply a first scan start signal to a first odd-numbered stage of the odd-numbered stages;
a second scan start signal line disposed in the peripheral area and configured to apply a second scan start signal to a first even-numbered stage of the even-numbered stages after all of the odd-numbered stages are driven;
a first pixel circuit portion disposed in the display area, electrically connected to the first odd-numbered stage, and connected to a first light-emitting diode that emits a first color; and
a second pixel circuit portion disposed in the display area, electrically connected to the first odd-numbered stage, spaced apart from the first pixel circuit portion in a first direction, and connected to a second light-emitting diode that emits a second color different from the first color.

2. The display device of claim 1, further comprising:
a third pixel circuit portion disposed in the display area, electrically connected to the first even-numbered stage, spaced apart from the first pixel circuit portion in a second direction intersecting the first direction, and connected to a third light-emitting diode that emits a third color different from the first and second colors; and
a fourth pixel circuit portion disposed in the display area, electrically connected to the first even-numbered stage, spaced apart from the third pixel circuit portion in the first direction, and connected to a fourth light-emitting diode that emits the third color.

3. The display device of claim 1, wherein the odd-numbered stages are electrically connected to each other by an odd carry line, and
the even-numbered stages are electrically connected to each other by an even carry line.

4. The display device of claim 2, wherein the first pixel circuit portion and the third pixel circuit portion are symmetrical in a plan view about a virtual extension line extending in the first direction between the first pixel circuit portion and the third pixel circuit portion.

5. The display device of claim 2, further comprising:
a first gate line disposed in the display area and extending in the first direction from the first odd-numbered stage; and
a second gate line disposed in the display area and extending in the first direction from the first even-numbered stage.

6. The display device of claim 5, wherein the first gate line is electrically connected to the first pixel circuit portion and the second pixel circuit portion, and
the second gate line is electrically connected to the third pixel circuit portion and the fourth pixel circuit portion.

7. The display device of claim 2, wherein the first, second, third, and fourth light-emitting diodes are disposed in a Pentile matrix structure.

8. The display device of claim 7, wherein at least a portion of the first light-emitting diode overlaps the first pixel circuit portion in a plan view,
at least a portion of the second light-emitting diode overlaps the third pixel circuit portion in the plan view,
at least a portion of the third light-emitting diode overlaps the second pixel circuit portion in the plan view, and
at least a portion of the fourth light-emitting diode overlaps the fourth pixel circuit portion in the plan view.

9. The display device of claim 2, wherein the first color is red, the second color is blue, and the third color is green.

10. The display device of claim 2, wherein the first color is blue, the second color is red, and the third color is green.

11. The display device of claim 2, further comprising:
a data driver disposed in the peripheral area and spaced apart from the display area in a direction opposite to the second direction,
wherein the data driver includes a first amplifier and a second amplifier spaced apart from the first amplifier in the first direction.

12. The display device of claim 11, further comprising:
a first data line extending in the second direction from the first amplifier and disposed in the display area; and
a second data line extending in the second direction from the second amplifier and disposed in the display area.

13. The display device of claim 12, wherein the first data line is electrically connected to the first pixel circuit portion and the third pixel circuit portion, and
the second data line is electrically connected to the second pixel circuit portion and the fourth pixel circuit portion.

14. The display device of claim 12, wherein the first amplifier alternately applies a first data voltage and a second data voltage to the first data line, and
the second amplifier alternately applies the second data voltage and a third data voltage to the second data line.

15. The display device of claim 14, wherein the first data voltage applied from the first amplifier is applied to the first pixel circuit portion,
the second data voltage applied from the first amplifier is applied to the third pixel circuit portion,
the second data voltage applied from the second amplifier is applied to the fourth pixel circuit portion, and
the third data voltage applied from the second amplifier is applied to the second pixel circuit portion.

16. The display device of claim 14, wherein the first amplifier applies the first data voltage to the first data line during a timing when the odd-numbered stages are driven, and applies the second data voltage to the first data line during a timing when the even-numbered stages are driven, and
the second amplifier applies the third data voltage to the second data line during a timing when the odd-numbered stages are driven, and applies the second data voltage to the second data line during a timing when the even-numbered stages are driven.

17. A method of driving a display device, comprising:
applying a first data voltage to a first data line during a timing when odd-numbered stages are driven by a first amplifier,
wherein the display device includes a display panel including a display area and a peripheral area surrounding at least a portion of the display area, a gate driver disposed in the peripheral area and including the odd-numbered stages and even-numbered stages, and a data driver disposed in the peripheral area and including the first amplifier and a second amplifier spaced apart from the first amplifier in a first direction;
applying a second data voltage to the first data line during a timing when the even-numbered stages are driven by the first amplifier;
applying a third data voltage to a second data line during a timing when the odd-numbered stages are driven by the second amplifier; and
applying the second data voltage to the second data line during a timing when the even-numbered stages are driven by the second amplifier,
wherein the odd-number stages are driven sequentially, and the even-numbered stages are driven sequentially after all of the odd-numbered stages are driven.

18. The method of claim 17, further comprising:
driving a first odd-numbered stage of the odd-numbered stages using a first scan line;
driving a first even-numbered stage of the even-numbered stages using a second scan line;
sequentially driving the odd-numbered stages from the first odd-numbered stage to a last odd-numbered stage; and
sequentially driving the even-numbered stages from the first even-numbered stage to a last even-numbered stage after the odd-numbered stages have been driven.

19. The method of claim 17, further comprising:
driving a first odd-numbered stage of the odd-numbered stages using a scan start line;
sequentially driving the odd-numbered stages from the first odd-numbered stage to a last odd-numbered stage; and
sequentially driving the even-numbered stages from a last even-numbered stage to a first even-numbered stage,
wherein a carry line extending from the last odd-numbered stage drives the last even-numbered stage of the even-numbered stages.

20. An electronic device, comprising:
a display device; and
a processor configured to drive the display device,
wherein the display device includes:
a display panel including a display area and a peripheral area surrounding at least a portion of the display area;
a gate driver disposed in the peripheral area and including odd-numbered stages and even-numbered stages;
a first scan start signal line disposed in the peripheral area and configured to apply a first scan start signal to a first odd-numbered stage of the odd-numbered stages;
a second scan start signal line disposed in the peripheral area and configured to apply a second scan start signal to a first even-numbered stage of the even-numbered stages after all of the odd-numbered stages are driven;
a first pixel circuit portion disposed in the display area, electrically connected to the first odd-numbered stage, and connected to a first light-emitting diode that emits a first color;
a second pixel circuit portion disposed in the display area, electrically connected to the first odd-numbered stage, spaced apart from the first pixel circuit portion in a first direction, and connected to a second light-emitting diode that emits a second color different from the first color;
a third pixel circuit portion disposed in the display area, electrically connected to the first even-numbered stage, spaced apart from the first pixel circuit portion in a second direction intersecting the first direction, and connected to a third light-emitting diode that emits a third color different from the first and second colors; and
a fourth pixel circuit portion disposed in the display area, electrically connected to the first even-numbered stage, spaced apart from the third pixel circuit portion in the first direction, and connected to a fourth light-emitting diode that emits the third color.
